(19) United States
(12) Patent Application Publication
(10) Pub. No.: US 2026/0242151 A1
(43) Pub. Date: Aug. 20, 2026

(54) Roller Module for Roller Conveyor with Tub-Like Base Body

(71) Applicant: Robert Bosch GmbH, Stuttgart (DE)

(72) Inventor: Sven Wlodarczyk, Ingersheim (DE)

(21) Appl. No.: 19/539,763

(22) Filed: Feb. 13, 2026

(30) Foreign Application Priority Data
Feb. 20, 2025 (DE) 10 2025 106 400.8

(51) Int. Cl. B65G 39/12; B65G 13/07; B65G 13/071; B65G 13/073; B65G 15/60; B65G 17/38; B65G 17/40; B65G 23/08; B65G 39/02; B65G 39/09

(52) U.S. Cl. CPC B65G 39/12; B65G 13/07; B65G 13/071; B65G 13/073; B65G 15/60; B65G 17/385; B65G 17/40; B65G 23/08; B65G 39/02; B65G 39/09

(57) ABSTRACT

A roller conveyor having a king shaft drive is disclosed. A base body of a roller module configured in a tub-like manner is also disclosed.

This application claims priority under 35 U.S.C. § 119 to application no. DE 10 2025 106 400.8, filed on Feb. 20, 2025 in Germany, the disclosure of which is incorporated herein by reference in its entirety.

### BACKGROUND

The disclosure relates to a roller module according to the description set forth below and a roller conveyor having such a roller module.

A roller conveyor is known from EP 2 163 495 B1, which is designed for relatively light conveyed material. The conveyor rollers extend over the entire width of the conveyor section, wherein only their ends opposite the roller axis featuring circular cylindrical sections on which the conveyed material rests. The conveyed material is, for example, approximately rectangular transport plates that are to be loaded with parts to be produced, for example, within a production plant. The conveyor rollers are each provided with a single pivot bearing at their two opposite ends in the direction of the roller axis. The drive of the conveyor rollers is carried out with a so-called king shaft drive, which is also used in the context of the present disclosure.

From DE 10 2022 203 906 A1, a roller conveyor developed based on EP 2 163 495 B1 is known, which is suitable for heavier conveyed material. The conveyed material is, for example, battery modules for electrically operated motor vehicles, wherein the roller conveyor is used in the manufacture and/or disassembly thereof. The increase in the carrying capacity was achieved, among other things, by providing two or more separate tracks of small conveyor rollers. Each conveyor roller is mounted with two pivot bearings per se. The conveyor rollers together with the pivot bearing and the two drive wheels are modular in design with the corresponding roller module fixed to a support profile of the roller conveyor extending along a conveyor direction.

In the context of the present disclosure, based on DE 10 2022 203 906 A1, a roller conveyor with further increased carrying capacity is to be created in order to transport even heavier battery modules. The support profile used and the width of the conveyor sections measured between the side guides are to remain the same. Accordingly, the roller module is to be configured such that larger pivot bearings can be used, wherein the conveyor rollers are simultaneously configured more solidly. The wall thickness of the conveyor rollers is to be large enough that a sleeve-like sheath made of metal can be used as needed, which has at least a wall thickness of 4 mm. The roller modules are also to be configured to absorb the forces acting transversely to the conveyor direction during conveyor operation. These may be forces that are introduced into the roll module via the side guide. It may also be in the frictional forces introduced into the roller module via the peripheral surface of the conveyor roller. The roller assemblies and the drive are to be attachable to the support profile at any distance. This allows a flexible adjustment to the load and the dimension of the part carriers.

### SUMMARY

According to the description set forth below, it is proposed that the roller module comprises an integral base body, which can be attached directly to the associated support profile, wherein the base body is tub-like, such that it forms a roller recess which is open toward the conveying plane, wherein the drive assembly comprises an axis body, which is arranged concentrically to the roller axis, wherein it has a first and an opposite second end in the direction of the roller axis, wherein it spans the roller recess such that it is supported at the first and second end perpendicular to the conveying plane on the base body, wherein the conveyor roller annularly surrounds the axis body, such that it extends in sections into the roller recess, wherein the first and the second pivot bearing are arranged within the conveyor roller, wherein they are received there on the axis body, wherein the first drive wheel annularly surrounds the axis body, wherein it extends in sections into the roller recess, wherein it is directly fixedly connected to the associated conveyor roller, wherein the base body comprises a first side wall in the area of the first end of the axis body, which is oriented transversely to the roller axis, wherein the second drive wheel is formed large enough that the drive shaft is arranged in the direction of the roller axis at a distance from the first side wall outside the base body.

The first and second drive edges are preferably each configured as a bevel gear, wherein they mesh directly with each other. The aforementioned bevel gears are preferably straight-toothed, wherein they can also be helical-toothed or arc-toothed. The support profile preferably extends with a constant, substantially rectangular cross-sectional shape parallel to the conveying direction, wherein it is most preferably made of aluminum in the extrusion process. The said cross-sectional shape preferably forms at least one undercut groove, which is most preferably T-shaped. The base body and the auxiliary body explained below are preferably screwable to the support profile with at least one undercut groove, most preferably using at least one groove nut and/or a hammer screw. The axis body is preferably designed in one piece.

Advantageous developments and improvements of the disclosure are also specified in the description set forth below.

It can be provided that the roller module comprises an integral auxiliary body that directly contacts the base body so that it is aligned relative to the base body, wherein the auxiliary body is directly attachable to the support profile associated with the base body, wherein the respective third pivot bearing is received in the auxiliary body. This makes it possible to increase the outer diameter of the conveyor roller relative to the diameter of the drive wheels, so that a solid and load-bearing conveyor roller results. The attachment of the auxiliary body is nonetheless stable, wherein an exact alignment of the first and the second drive wheels is ensured for a low-wear meshing engagement.

It may be provided that the axis body is exclusively held on the base body at its first end in the direction of the roller axis. As a result, deformations resulting from the drive forces have only a minor effect on the gear meshing.

It may be provided that a first screw concentric to the roller axis is associated with the axis body, which is screwed into the axis body on the front side at the first end, wherein it intersects the base body, wherein a first support recess is provided in the base body adjacent to the screw, into which the axis body engages positively so that it is supported perpendicular to the conveying plane. The first screw preferably penetrates the first side wall of the base body, in particular a circular breakthrough in the first side wall. On the opposite side of the roller recess, namely at the second end of the axis body, the base body preferably has a second support recess, in which the axis body engages positively so that it is supported perpendicular to the conveyor plane. The first and second support recesses are preferably open towards the conveying plane, so that the axis body can be easily mounted on the base body. Accordingly, they only provide support with respect to a force that is directed away from the conveyor level. This force is preferably the weight force of the conveyed material, which is transported with the roller conveyor.

It may be provided that the axis body is provided with a pair of key surfaces at the first and/or second end, which engage positively in an adjusted first or second support recess in the base body so that the axis body is secured against twisting with respect to the roller axis. The corresponding anti-rotation feature is particularly inexpensive. It also prevents the first screw from coming loose.

It may be contemplated that the first drive wheel comprises at least two snap hooks extending in the direction of the roller axis, wherein they are directly latched to the conveyor roller. The corresponding connection is particularly inexpensive, whereby it can be easily mounted. The snap hooks are preferably arranged uniformly around the roller axis, wherein they are most preferably identical in design.

It may be provided that in addition to the positive engagement between the snap hooks and the conveyor roller, further a positive locking mechanism are provided that cause a positive transmission of torque between the first drive wheel and the conveyor roller. By this, the snap hooks may be formed resiliently such that the assembly of the first drive wheel on the conveyor roller may be carried out with low force. Nevertheless, the corresponding connection may transmit a sufficiently high torque. The mentioned positive locking mechanism are preferably front grooves on the conveyor roller, into which adapted projections on the first drive wheel engage.

A separate, integral cover body may be provided, which is fixedly connected to the base body so that it partially covers the roller recess, wherein the conveyor roller intersects a breakthrough in the cover body, such that the conveyor plane is arranged at a distance to the cover body, wherein the first drive wheel is arranged in the direction of the roller axis adjacent to the cover body. A first drive wheel having a large diameter may thereby be used. The cover body is preferably plate-like, wherein it is arranged parallel to the conveying plane. The cover body is preferably attached, in particular screwed, exclusively to the base body. The corresponding second screws are preferably arranged in the corners of an imaginary rectangle

It may be provided that the conveyor roller is integrally formed, being made of plastic or metal. Such a conveyor roller may support large forces.

It may be provided that the conveyor roller comprises a sleeve-like sheath of metal forming the peripheral surface, wherein a core of plastic is arranged within the sheath to which the first and the second pivot bearing are attached. Such a conveyor roller may support even greater forces than the integral conveyor roller discussed above. The mentioned shell is preferably made of steel.

Protection is also sought for a roller conveyor, wherein the roller conveyor comprises at least two support profiles extending parallel to the conveying direction, wherein they are fixedly connected to one another, wherein a plurality of roller modules according to the disclosure are attached to each support profile, wherein all roller axes are aligned parallel to one another, wherein the drive axes associated with a support profile coincide with each other. The roller modules are preferably arranged uniformly along the relevant support profile. The roller conveyor can comprise at least one drive motor, which is in rotational connection with a respective associated drive shaft away from the roller modules, wherein the drive motor is attached to the support profile associated with the respective drive shaft.

It may be provided that a drive shaft is associated with each support profile, which is in drive connection with all roller modules of the respective support profile, wherein at least one auxiliary shaft is provided, via which two adjacent drive shafts are in a rotational drive connection, wherein the auxiliary shaft is aligned parallel to the roller axes, wherein the aforementioned rotational drive connection is made away from the roller modules. The roller conveyor according to the disclosure requires significantly fewer roller modules than the known roller conveyors because of its highly load-bearing roller modules. The distance between the roller modules can thus be greater than with the known roller conveyors. The space thus created between the roller modules can be used for the drive connection of the two drive shafts. The corresponding drive design can subsequently be designed significantly simpler than with the known conveyor. The auxiliary body with the third pivot bearing and the second drive wheel can in particular be used unchanged for this purpose.

It can be provided that at least one support profile is associated with a side guide that extends parallel to the conveying direction, wherein the side guide is fixed exclusively to the cover bodies associated with the support profile, wherein it is attached to a plurality of cover bodies. In the case of service, the assembly consisting of the side guide and the associated covers as a whole can be disassembled or reassembled. This saves working time. In the initial assembly, preferably the cover bodies are first attached to the base bodies and then the side guides are then attached to the respectively assigned cover bodies to ensure that they are aligned with each other.

Of course, the above-mentioned features and those to be explained below can be used not only in the combination indicated in each case, but also in other combinations or on their own, without going beyond the scope of the present disclosure.

### BRIEF DESCRIPTION OF THE DRAWINGS

The disclosure is explained in more detail below with reference to the enclosed drawings. The figure shows:

FIG. 1 a roller conveyor with a plurality of roller modules according to the disclosure;

FIG. 2 a perspective view of a roller module according to the disclosure, which is mounted on an associated support profile;

FIG. 3 a partial perspective view of the assembly of FIG. 1 in which the first drive wheel is visible;

FIG. 4 a longitudinal section of the conveyor roller with the axis body;

FIG. 5 a perspective view of the conveyor roller from the first end of the axis body; and

FIG. 6 a perspective view of the tub-like base body.

### DETAILED DESCRIPTION

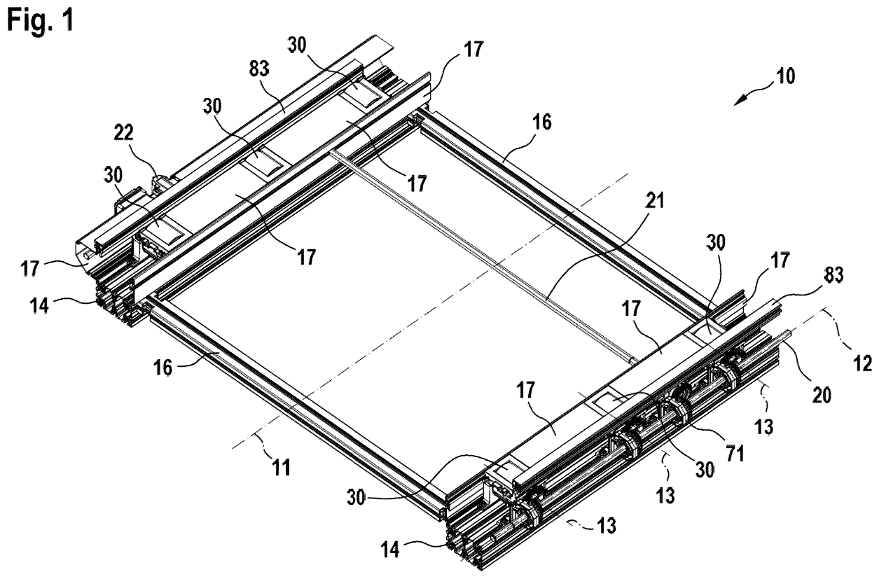

FIG. 1 shows a roller conveyor 10 with a plurality of roller modules 30 according to the disclosure. The roller conveyor 10 comprises two support profiles 14 that extend parallel to a conveying direction 11. The support profiles 14 are made of aluminum in the extrusion process so that they have a constant cross-sectional shape over their entire length. The support profiles 14 are fixedly connected to each other via connection struts 16, wherein the connection struts 16 are also embodied as an aluminum profile.

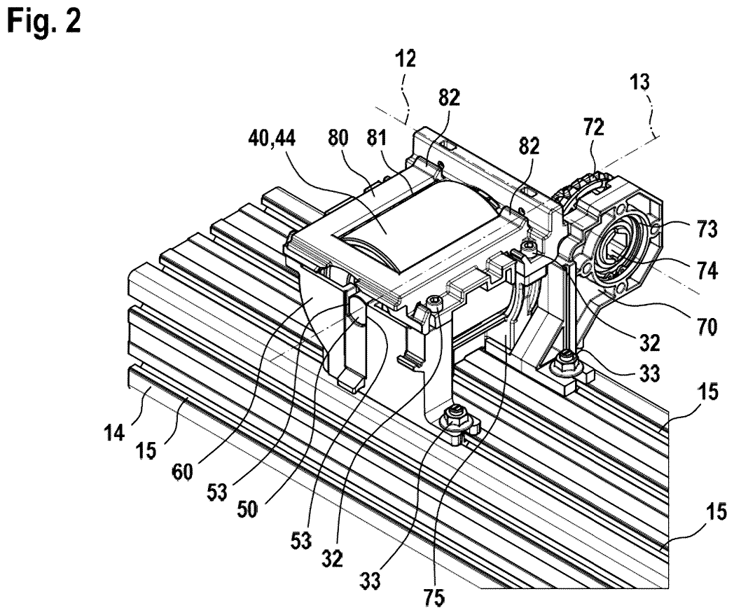

A plurality of roller modules 30 is attached to each support profile 14, wherein the roller modules 30 are arranged uniformly along the conveying direction 11. Each roller module 30 defines a roller axis 13 and a drive axis 12. All roller axes 13 are aligned parallel to each other and perpendicular to the conveying direction 11. The drive axes 12, which are associated with a support profile 14, coincide so that all roller modules 30 of a support profile 14 can be driven with a common drive shaft 20. A corresponding drive is known from EP 2 163 495 B1. The rotational drive connection between the drive shaft 20 and the roller modules 30 can be optionally configured with or without a slip clutch. The drive shaft 20 has a hexagonal cross-sectional shape over its entire length, engaging with an adjusted drive breakthrough (no. 74 in FIG. 2) of the relevant second drive wheels.

The entire drive is enclosed with various covers 17 to prevent operator injuries. In FIG. 1, a portion of the covers 17 is removed so that the internal structure of the drive is visible.

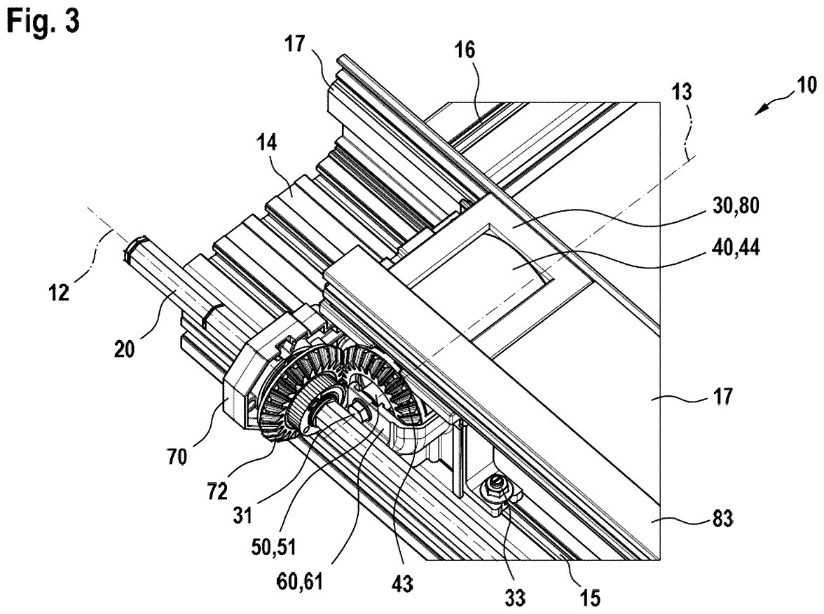

Reference is still made to the auxiliary shaft 21, which extends parallel to the roller axes 13. The two drive shafts 20 are in rotational drive connection via the auxiliary shaft 21. It is provided at its opposite ends with drive wheels analogous to the first drive wheels (no. 43 in FIG. 3), which mesh with drive wheels analogous to the second drive wheels (no. 72 in FIG. 2). The latter drive wheels, including the auxiliary body 71 and the third pivot bearing (no. 73 in FIG. 2), are identical to the corresponding parts on the roller module 30 according to the disclosure.

Furthermore, in FIG. 1, two side guides 83 attached to each of the associated roller modules 30 can be seen. In addition, the drive motor 22 is visible in the form of an electric gear motor, which is in rotational drive connection similar to the auxiliary shaft 21 with the associated drive shaft 20. In both cases, the rotational drive connection to the drive shaft 20 is located away from the roller modules 30.

FIG. 2 shows a perspective view of a roller module 30 according to the disclosure, which is attached on an associated support profile 14. The support profile 14 is provided with a plurality of undercut grooves 15, which are preferably T-shaped when viewed in cross section. Third screws 33 engage the under-cut grooves 15, which in the present case are configured as hammer screws with screwed-on collar nuts, and via which the base body 60 and the auxiliary body 70 are screwed to the support profile 14.

The base body 60 and the auxiliary body 70, each of which are integrally formed, abut an alignment contour 75 immediately against one another so that they are precisely aligned relative to one another, in particular, the roller axis 13 and the drive axis 12 are aligned perpendicular to one another. The auxiliary body 70 supports a third pivot bearing 73, which in the present case is configured as a radial groove ball bearing. In the third pivot bearing 73, a second drive wheel 72 is rotatably received relative to the drive axis 12. In the present case, the second drive wheel 72 is formed in the form of a straight-toothed bevel gear that meshes with an adjusted first drive gear (no. 43 in FIG. 3) and which is rotationally fixedly connected to the conveyor roller 40.

In the base body 60, the conveyor roller 40 is rotatably received relative to the roller axis 13. The roller recess of the tub-like base body 60 is covered with a cover body 80, wherein the cover body 80 has a rectangular breakthrough 81 through which the conveyor roller 40 projects outwardly so that its peripheral surface 44 can contact the conveyed material in the area of the conveyor plane. The cover body 80 is screwed to the base body 60 by way of four second screws 32, only two of which are visible in FIG. 2. The cover body 80 is provided with a fastening contour 82 to which the side guide 83 is attached.

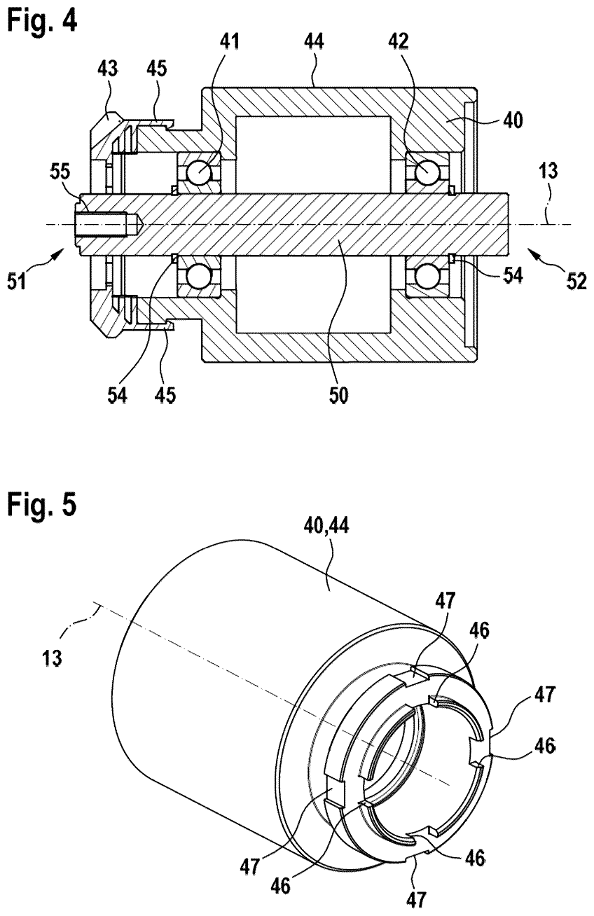

Furthermore, in FIG. 2, the second end (no. 52 in FIG. 4) of the axis body 50 is visible, which is provided with a pair of spanner flats 53 that are formed planar and parallel to each other. The base body 60 has adapted mating surfaces so that the axis body 50 is secured against twisting about the roller axis 13.

FIG. 3 shows a partial perspective view of the assembly of FIG. 1 in which the first drive wheel 43 is visible. The first end 51 of the axis body 50 is screwed to the first side wall 61 of the base body 60 by way of a first screw 31. The first screw 31 is arranged concentrically to the roller axis 13, wherein it is screwed in the front side of the axis body 50, wherein it intersects a circular breakthrough in the first side wall 61.

The conveyor roller 40 is fixedly connected to a first drive wheel 43 that surrounds the axis body 50, which extends in portions into the roller recess 65 of the base body 60. The first drive wheel 43 is arranged in the direction of the roller axis 13 adjacent to the cover body 80, wherein the cover body 80 partially covers the roller recess 65 of the base body 60. The side guide 83 is fixedly connected to the cover body 80 such that it does not contact the first drive wheel 43.

The first drive gear 43 is also configured as a straight-toothed bevel gear, in which it directly meshes with the second drive gear 72. The drive shaft 20 rotatable with respect to the drive axis 12 has a hexagonal cross-sectional shape over its entire length, wherein it is arranged outside the tub-like base body 60. In particular, it is arranged in the direction of the roller axis 13 at a distance to the first side wall 61 and beyond that at a distance to the head of the first screw 31.

FIG. 4 shows a longitudinal section of the conveyor roller 40 with the axis body 50. The section plane contains the roller axis 13. The conveyor roller 40 is in the present case integrally formed. It has a circular cylindrical peripheral surface 44 relative to the roller axis 13. The peripheral surface 44 can alternatively also be formed from a separate, sleeve-like sheath made of metal, which preferably has a wall thickness of at least 4 mm. The conveyor roller 40 is configured in a tubular manner with respect to the roller axis 13 such that it annularly surrounds the axis body 50. A first pivot bearing 41 and a second pivot bearing 42 are accommodated within the conveyor roller 40, which in the present case are respectively configured as radial groove ball bearings. The inner rings of the first pivot bearing 41 and the second pivot bearing 42 that are concentric to the roller axis 13 are intersected by the axis body 50, which is formed substantially circular cylindrical with respect to the roller axis 13 over its entire length. The axial support on the first pivot bearing 41 and on the second pivot bearing 42 is effected by way of a retaining ring 54, which is received in an adapted groove in the axis body 50.

Furthermore in FIG. 4, the snap hooks 45 with which the first drive wheel 43 is immediately snapped onto the conveyor roller 40 can be seen. The snap hooks 45 extend parallel to the roller axis 13, wherein they are formed elastically.

In addition, in FIG. 4, the first thread 55 can be seen on the axis body 50 in which the first screw 31 is screwed.

FIG. 5 shows a perspective view of the conveyor roller 40 from the first end of the axis body. The grooves 47 extending parallel to the roller axis 13, which are adapted to the snap hooks 45, can be seen. These grooves 47 already cause a positive locking rotation between the first drive wheel 43 and the conveyor roller 40. In addition to the snap hooks on the first drive wheel, a further positive locking mechanism 46 are provided on the conveyor roller 40, into which adapted counter-positive locking mechanism on the first drive wheel engage in a positive manner. The four positive locking mechanism 46 in the present case are each configured as a front groove, which extends radially to the roller axis 13.

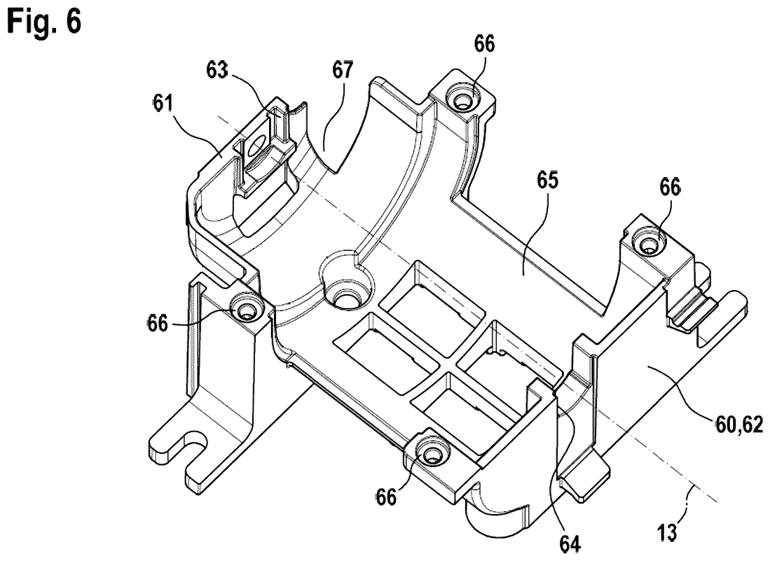

FIG. 6 shows a perspective view of the tub-like base body 60. The integral base body 60 is made of, for example, aluminum or zinc in the die-casting process. The base body 60 forms a roller recess 65 that is adapted at a distance to the conveyor roller 40. At the top, the base body 60 has a total of four second threads 66 arranged in the corners of an imaginary rectangle. The planar surfaces surrounding the second threads 66 lie in a common plane with mating surfaces arranged on the cover body 80.

The shape of the base body 60 is designed to be manufacturable with a two-piece casting tool that opens perpendicular to the conveying plane, with very few shape sliders. Accordingly, the first support recess 63 and the second support recess 64 are configured to be open upwardly, so that they only support the downwardly acting weight force acting on the axis body. The first support recesses 63 and the second support recesses 64 each have two parallel opposite side walls, which are oriented perpendicular to the conveying plane and parallel to the roller axis 13. These are each adapted to the associated spanner flats (no. 53 in FIG. 2) on the axis body in the sense of an anti-rotation feature.

In the area of the first side wall 61, the base body 60 has a drive breakthrough 74, which is intersected by the first drive wheel 43 so that it can mesh with the second drive wheel 72. All of the remaining breakthroughs and recesses on the base body 60 are primarily for material savings. They are arranged and sized so that the stiffening effect of the tub shape is retained as much as possible.

The base body 60 and the cover body (no. 80 in FIG. 3) are preferably adapted to the conveyor roller (no. 40 in FIG. 3) such that any gaps into which objects could retract due to the rotational movement of the conveyor roller are less than 5 mm.

### Reference Numerals

10 Roller conveyor
11 Conveying direction
12 Drive axis
13 Roller axis
14 Support profile
15 Undercut groove
16 Connecting strut
17 Cover
20 Drive shaft
21 Auxiliary shaft
22 Drive motor
30 Roller module
31 First screw
32 Second screw
33 Third screw
40 Conveying roller
41 First pivot bearing
42 Second pivot bearing
43 First drive wheel
44 Peripheral surface
45 Snap hook
46 Positive locking mechanism
47 Groove
50 Axis body
51 First end
52 Second end
53 Spanner flat
54 Retaining ring
55 First thread
60 Base body
61 First side wall
62 Second side wall
63 First support recess
64 Second support recess
65 Roller recess
66 Second thread
67 Drive breakthrough
70 Auxiliary body
71 Auxiliary body for drive
72 Second drive wheel
73 Third pivot bearing
74 Drive breakthrough
75 Alignment contour
80 Cover body
81 Breakthrough
82 Attachment contour
83 Side guide
84 Recess

What is claimed is:

1. A roller module for use in a roller conveyor, wherein a support profile of the roller conveyor is associated with the roller module, which extends parallel to a conveying direction, wherein the roller module comprises a conveyor roller, which is rotatably supported with respect to a roller axis by way of a first and a second pivot bearing, wherein the conveyor roller is connected in a rotationally fixed manner to a first drive wheel, wherein a second drive gear is rotatably supported with a third pivot bearing relative to a drive axis parallel to the conveying direction, wherein the drive axis is aligned perpendicular to the roller axis, wherein the first and second drive wheels are in rotational drive connection, wherein the second drive gear is configured to be brought into rotational drive connection with an associated drive shaft of the roller conveyor that is rotatable relative to the drive axis, wherein a conveying plane is aligned parallel to the drive axis and the roller axis, tangentially contacting a peripheral surface of the conveyor roller, wherein the roller module comprises an integral base body, which is configured to be attached directly to the associated support profile, wherein the base body is tub-like, such that it forms a roller recess which is open toward the conveying plane, wherein the drive assembly comprises an axis body, which is arranged concentrically to the roller axis, wherein it has a first and an opposite second end in the direction of the roller axis, wherein it spans the roller recess such that it is supported at the first and second end perpendicular to the conveying plane on the base body, wherein the conveyor roller annularly surrounds the axis body, such that it extends in sections into the roller recess, wherein the first and the second pivot bearing are arranged within the conveyor roller, wherein they are received there on the axis body, wherein the first drive wheel annularly surrounds the axis body, wherein it extends in sections into the roller recess, wherein it is directly fixedly connected to the associated conveyor roller, wherein the base body comprises a first side wall in the area of the first end of the axis body, which is oriented transversely to the roller axis, wherein the second drive wheel is formed large enough that the drive shaft is arranged in the direction of the roller axis at a distance from the first side wall outside the base body.

2. The roller module according to claim 1, wherein the roller module comprises an integral auxiliary body that directly contacts the base body so that it is aligned relative to the base body, wherein the auxiliary body is directly attachable to the support profile associated with the base body, and wherein the respective third pivot bearing is received in the auxiliary body.

3. The roller module according to claim 1, wherein the axis body is held exclusively at its first end on the base body in the direction of the roller axis.

4. The roller module according to claim 3, wherein a first screw concentric to the roller axis is associated with the axis body, which is screwed into the axis body on the front side at the first end, wherein it intersects the base body, wherein a first support recess is provided in the base body adjacent to the screw, into which the axis body engages positively so that it is supported perpendicular to the conveying plane.

5. The roller module according to claim 1, wherein the axis body is provided with a pair of key surfaces at the first and/or second end, which engage positively in an adjusted first or second support recess in the base body so that the axis body is secured against twisting with respect to the roller axis.

6. The roller module according to claim 1, wherein the first drive wheel comprises at least two snap hooks extending in the direction of the roller axis, and wherein they are directly latched to the conveyor roller.

7. The roller module according to claim 6, wherein in addition to the positive engagement between the snap hooks and the conveyor roller, a further positive locking mechanism is provided that cause a positive transmission of torque between the first drive wheel and the conveyor roller.

8. The roller module according to claim 1, wherein a separate, integral cover body is provided, which is fixedly connected to the base body so that it partially covers the roller recess, wherein the conveyor roller intersects a breakthrough in the cover body, such that the conveyor plane is arranged at a distance to the cover body, and wherein the first drive wheel is arranged in the direction of the roller axis adjacent to the cover body.

9. The roller module according to claim 1, wherein the conveyor roller is integrally formed, being made of plastic or metal.

10. The roller module according to claim 1, wherein the conveyor roller comprises a sleeve-like sheath of metal forming the peripheral surface, and wherein a core of plastic is arranged within the sheath to which the first and the second pivot bearing are attached.

11. A roller conveyor having at least two support profiles extending parallel to the conveying direction, wherein they are fixedly connected to one another, wherein a plurality of roller modules are attached to each support profile, each of which is configured according to claim 1, wherein all roller axes are aligned parallel to one another, and wherein the drive axes associated with a support profile coincide with each other.

12. The roller conveyor according to claim 11, wherein a drive shaft is associated with each support profile, which is in drive connection with all roller modules of the respective support profile, wherein at least one auxiliary shaft is provided, via which two adjacent drive shafts are in a rotational drive connection, wherein the auxiliary shaft is aligned parallel to the roller axes, and wherein the aforementioned rotational drive connection is made away from the roller modules.

13. The roller conveyor according to claim 11, wherein a separate, integral cover body is provided, which is fixedly connected to the base body so that it partially covers the roller recess, wherein the conveyor roller intersects a breakthrough in the cover body, such that the conveyor plane is arranged at a distance to the cover body, and wherein the first drive wheel is arranged in the direction of the roller axis adjacent to the cover body, and wherein at least one support profile is associated with a side guide extending parallel to the conveying direction, wherein the side guide is fixed exclusively to the cover bodies associated with the support profile, and wherein it is fixed to a plurality of cover bodies.
